(19) United States
(12) Patent Application Publication
(10) Pub. No.: US 2016/0371865 A1
(43) Pub. Date: Dec. 22, 2016

(54) SYSTEM AND METHOD FOR DEPLOYING SENSOR BASED SURVEILLANCE SYSTEMS

(71) Applicant: Eran JEDWAB, Modi'in (IL)

(72) Inventor: Eran JEDWAB, Modi'in (IL)

(21) Appl. No.: 15/181,474

(22) Filed: Jun. 14, 2016

(30) Foreign Application Priority Data
Jun. 18, 2015 (IL) 239524

(51) Int. Cl. G06T 11/60; G08B 13/196; G06T 11/20; G06K 9/00; H04N 7/18; G06T 7/60; H04L 29/08; H04L 12/24

(52) U.S. Cl. CPC G06T 11/60; H04L 67/12; G08B 13/19639; H04L 41/145; G08B 13/19682; G06K 9/00771; H04N 7/181; G06T 7/60; G06T 11/203; G06T 2207/30232

(57) ABSTRACT

A system and a method for deploying sensor based surveillance systems, comprising the steps of calculating the optimal locations for a plurality of sensors to cover a specified target area, based on a-priori data of the target area; generating a continuous surface, mapping the whole region, surrounding the target area, analyzing every point in the region within the vicinity of the target area, as a potential location for deploying a sensor, and ranking the each point as to the portion of the specified target area that would be covered from the point by the deployed sensor, subject to the attributes of the sensor.

### FIELD OF THE INVENTION

The present invention relates to the field of surveillance systems. More particularly, the invention relates to a system and method for deploying sensor based surveillance systems.

### BACKGROUND OF THE INVENTION

Wide area, sensitive facilities, such as power plants, airports, forests or any other public or private sites, are often subject to security or safety threats. In order to prevent damages to property or even to prevent injury to innocent citizens in the facility or its surrounding area, a surveillance system is often employed. The surveillance system generally comprises sensors capable of scanning or observing an area surrounding the facility. Such sensing devices are positioned at different locations throughout the facility, in order to facilitate monitoring of the facility and its surroundings. Some of these devices are sensors capable of detecting events around the facility, while other imaging devices may be used for visual assessment of the detected threats. The image data and other sensed data including detection alerts are transmitted to a computerized system to allow further handling and response to the detected event.

Due to the complexity concerned with such field deployed systems, often, their deployments are contracted to system integration companies that design, implement and deploy the system on behalf of the end-customer. The deployment of such modern sensor based surveillance systems is a complex and laborious process typified by many unknown variables and risk factors.

Early on the first stages, even before a deployment contract is signed, preliminary bidding and proposals are assembled. During such early stages, resources are not yet available for full site analysis and therefore, preliminary plans are often vaguely outlined, based on rough estimations regarding the field conditions around the site and their implications on the performance of the final system. Because of this, such preliminary plans are highly prone to errors, requiring late amendments during the deployment project and bearing significant cost over-runs.

Later, during the deployment project, the system's detailed design is shaped through multiple physical site surveys. Through such field surveys, the survey teams have to physically traverse large areas in order to determine the optimal sensor placements. This often results in a prolonged and expensive process that still remains highly error prone to insufficient coverage that may be realized by the actual system—once deployed.

The final deployment plan, hard reached through prolonged and tedious field work, is unlikely to be further optimized through the right trade-off decisions, due to the required field revalidation. This often results in excessive and suboptimal deployment of sensors, boosting redundant costs.

Proper visualization of the system's coverage requires a flexible and tangible disclosure of the expected system's performance and of its underlying design considerations. In the lack of such disclosure, it is difficult for the contractor's staff to coordinate expectations with the end-customer and to assure all parties are fully aware of the design considerations and their implications. The customer, unaware of those implications may realize them upon the delivery of the system, only after the system's coverage may be fully tested and validated. Such lack of transparency through the project, may lead to post-deployment repairs and alterations, bearing the risks of considerable delays and cost over-runs.

In the worst cases, final coverage of the delivered system may suffer from gaps—unknown to the system integrator and to the end-customer. Such gaps may be the source of potential security or safety breaches.

As surveillance technology evolves, new types of sensors emerge in the market, exploiting wide variety of wavelengths and types of physical media. Such sensors may be subject to various propagation mechanisms. Therefore, line of sight analysis, typically used for the modeling of optical sensors such as cameras, may not deliver the proper coverage estimations for other types of sensors such as ground radars.

At times, the area required for analysis may be vastly wide, considerably increasing the computational complexity of a full analysis of the area for deployment of sensors.

During their field work, the survey team is required for some editing and outlining of geometrical shapes. Such a task is easily and comfortably carried out with a desktop computing environment through the use of a mouse and a keyboard. However, fine editing in the field, based on modern mobile devices, requires awkward combinations of gestures, pushing the user to only roughly outline the graphic objects, or to completely give up and defer such tasks to be done in the office.

The final system's control workstation utilizes geographical imagery mapping materials like Orthophotos of the monitored area. Such imagery data is used as a background for the workstation's geographical display and is usually purchased from external services and providers. Often, such imagery materials are not updated or suffer from low resolution and lack of details.

Deployment planning based computational tools, is usually conducted off-site. Through these planning sessions, complete deployment plans are generated for the site, by an analysis of the site's area as a whole. This is done by calculating the optimal locations for all the sensors, which are expected to deliver a satisfactory coverage of the specified area combined with a proper overlap between the coverages of adjacent sensors. Such complete plans are later validated in the field by the survey team. As opposed to those off-site planning sessions, the site survey team has to weigh various considerations and make their decisions in the field. In addition, the field survey team has the capability and therefore the responsibility to validate the logistic feasibilities of establishing sensor posts at the suggested locations, as well as of supporting these posts during the life cycle of the system. Through their field work, the survey team ratifies and ultimately fixes the locations of the sensors incrementally, on a location by location basis. Such characteristics and objectives, of the field site survey, cannot be adequately supported by a planning session that generates a complete plan, for all of the sensors, at a time. Moreover, every decision taken or updated in the field, regarding any sensor's location, may force the relocation of other sensors within the system, invalidating the whole plan. This effectively prevents the gradual formation of the plan and may drive the survey team to completely abandon the planning tools, retracting to unaided field guesswork.

It is an object of the present invention to provide a system and method to support the deployment of a sensor based surveillance system.

It is an object of the present invention to provide a system and method to enable thorough analysis of the site and its surroundings based on a-priori data of the area, available before the site is even visited.

It is an additional object of the present invention to provide a system and method to allow the system designer to produce preliminary analyses that will facilitate more reliable preliminary estimations of the expected number of sensors that will be required to properly cover the target area as specified by the customer.

It is an additional object of the present invention to provide a system and method to shorten the duration of physical site surveys and reduce the expenses associated with detailed design of a sensor based surveillance system.

It is an additional object of the present invention to provide a system and method to facilitate optimizations and trade-off decisions relating to the coverage of a sensor based surveillance system.

It is an additional object of the present invention to allow the system-designer to produce tangible visualizations of the system's design that will also serve as a platform for disclosing design decisions and their implications to the end-customer of a sensor based surveillance system.

It is an additional object of the present invention to provide a system and method to validate the system design, minimizing unknown gaps in the coverage of a sensor based surveillance system.

It is an additional object of the present invention to provide a system and method to model ground radar sensors to properly estimate the operational coverage of radar based surveillance systems.

It is an additional object of the present invention to provide a system and method to effectively calculate the best locations for sensors that will cover vastly wide areas while considerably reducing the complexity of such calculation.

It is an additional object of the present invention to provide a system and method that allows the survey team to precisely outline geometrical shapes in the field by use of simple gestures on a mobile device's touch screen interface.

It is an additional object of the present invention to provide a system and method to allow to capture the most updated, detailed and high resolution imagery data from the field and to overlay such detailed imagery data within the geographical display of the control workstation.

It is an additional object of the present invention to provide a system and method that will allow survey teams to utilize computational planning tools during their field work—reviewing, validating and ratifying locations for the system's sensors.

It is an additional object of the present invention to provide a system and method that will validate the adequate overlap between the coverages produced by adjacent sensors.

Other objects and advantages of the invention will become apparent as the description proceeds.

### SUMMARY OF THE INVENTION

The present invention provides a system and a method for deploying sensor based surveillance systems, comprising the steps of calculating the optimal locations for a plurality of sensors to cover a specified target area, based on a-priori data of the target area; generating a continuous surface, mapping the whole region, surrounding the target area, analyzing every point in the region within the vicinity of the target area, as a potential location for deploying a sensor, and ranking the each point as to the portion of the specified target area that would be covered from the point by the deployed sensor, subject to the attributes of the sensor.

In one aspect, such continuous surface mapping of field ranking is utilized by field site survey teams to focus on validating locations, suggested in advance, as to their logistical feasibility for establishing a sensor post and for servicing the post during the life cycle of the system.

In one aspect, estimating and visualizing the field coverage of the sensors from the optimized locations or from alternative locations are layered within the site's analysis product to allow comparisons and benchmarking of the alternative coverages, facilitating decision-making processes relating to optimizations and trade-offs that will assure adequate and effective sensor coverage and overlap of adjacent sensors.

In one aspect, such visualization of alternative coverages, delivered in a standard 3D format browsable by tools available to the end-customer, serves as a tangible disclosure of design considerations and their implications throughout the deployment project.

In one aspect, target area and expected system coverage are both visualized to enable the system designer as well as the end-customer to inspect and validate the adherence of the expected coverage to the specification of the target area for coverage.

In one aspect, a radar model is employed to estimate the operational coverage of ground radar sensors more reliably compared to line of sight analysis. Such radar model points on weak spots, susceptible to low detectability of intrusions.

In one aspect, adapting the sampling scheme of terrain models of vastly wide areas to the shape of the area's terrain to reduce the complexity of computing the optimal locations for sensors that will best cover the area.

In one aspect, employing graphical editing of objects, through simple touch based gestures on a mobile device to facilitate precise and easy field graphical editing.

In one aspect, dynamically geo-referencing images taken in the field to overlay detailed and updated field captured imagery data over the original geographical display of the system's control workstation.

In one aspect, calculating sensor placements and optimizations through a localized and incremental paradigm to properly support the workflow of field survey teams, conducted on a location by location basis.

In one aspect, assessing and validating adequate overlaps between coverages of adjacent sensors, utilizing standard route calculating methods.

### BRIEF DESCRIPTION OF THE DRAWINGS

In the drawings:

FIG. 1 is a schematic 3D illustration of the specified target area and its surroundings;

FIG. 2 is a schematic illustration of an analyzed area with rankings of each point in the area as to its quality as a location for sensor according to one embodiment of the present invention;

FIG. 3 is an illustration of the 3D product of the field analysis session, visualizing the expected coverage and acting as a platform for design disclosure, according to another embodiment of the invention;

FIG. 4 is an illustration of the 3D product of the field analysis session, following further optimization and trade-off decision, according to another embodiment of the invention;

FIG. 5 is a schematic illustration of a modified terrain sampling scheme, according to another embodiment of the invention;

FIG. 6 is an illustration of a precision geometrical editing through simple gestures, according to another embodiment of the invention;

FIG. 7 is a schematic illustration of geo-referencing field captured images, according to another embodiment of the invention;

FIG. 8 is a schematic illustration of blanking cluttering objects from field captured images, according to another embodiment of the invention;

FIG. 9 is a schematic illustration of the method for incremental sensor placement algorithm, according to another embodiment of the invention;

FIG. 10 is an illustration of the procedure of setting the starting point of the incremental sensor placement method, according to another embodiment of the invention;

FIG. 11 is an illustration of the gap filling procedures, according to another embodiment of the invention;

FIG. 12 is an illustration of the sensor range optimization procedure, according to another embodiment of the invention;

FIG. 13 is an illustration of the core procedure of finding a location with adequate coverage overlap, according to another embodiment of the invention;

FIG. 14 is a schematic illustration of the coverage overlap verification of adjacent sensors, according to another embodiment of the invention;

FIG. 15 is a schematic illustration of the disqualification of suggested locations, according to another embodiment of the invention; and

FIG. 16 is an illustration of the procedure initiated when a suggested location is disqualified, according to another embodiment of the invention.

### DETAILED DESCRIPTION OF PREFERRED EMBODIMENTS

The present invention is a sensor planning system and method for off-site design sessions and for on-site field surveys that accelerates the preliminary and detailed design of sensor based surveillance systems, estimates and validates the expected sensors' coverage of a specified target area, and visualizes the overall systems' coverage and the implications from decisions concerning its design.

Prior art deployment planning is based on rough estimations, prolonged field surveys and a lot of guesswork. In some cases, computerized mission planning tools are utilized to visualize the field around the protected site and to generate sensor coverage estimations, mainly through line of sight analyses. Such tools are utilized by the system designer mainly off-site to generate, in advance and each at a time, complete deployment plans, for all of the system's sensors. The present invention improves such capabilities by employing a holistic deployment planning and system design concept, aided by dedicated computational tools, whereby deployment risks are mitigated and collaboration with end-customers are improved. Moreover, such computational tools and planning products are fitted to the workflows typical of field site surveys. In addition, the present invention employs ground radar model to generate more reliable coverage estimations for radar based surveillance systems.

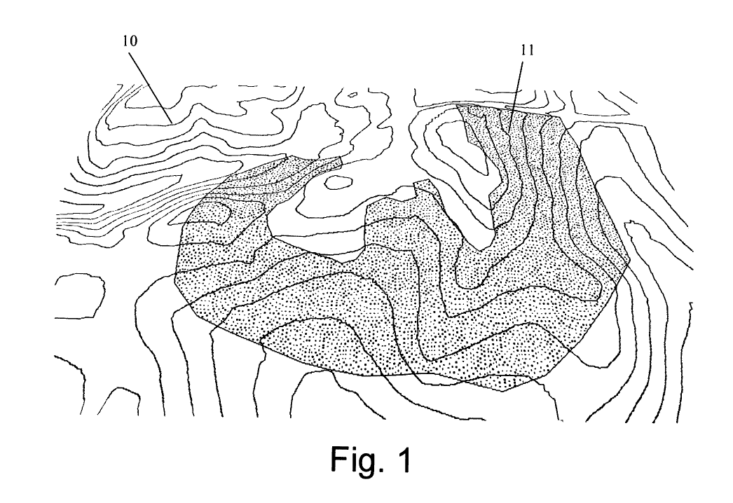

FIG. 1 schematically illustrates the information required for the planning of sensor deployment. The background data, representing the area surrounding the site, may be available prior to site visit in the form of a terrain model—10 representing the ground's shape, or a surface model representing structures and other objects above the ground. The target area, required for coverage by the system, is specified as a polygon—11, flexibly outlined by the customer, within the area represented by said terrain or surface model.

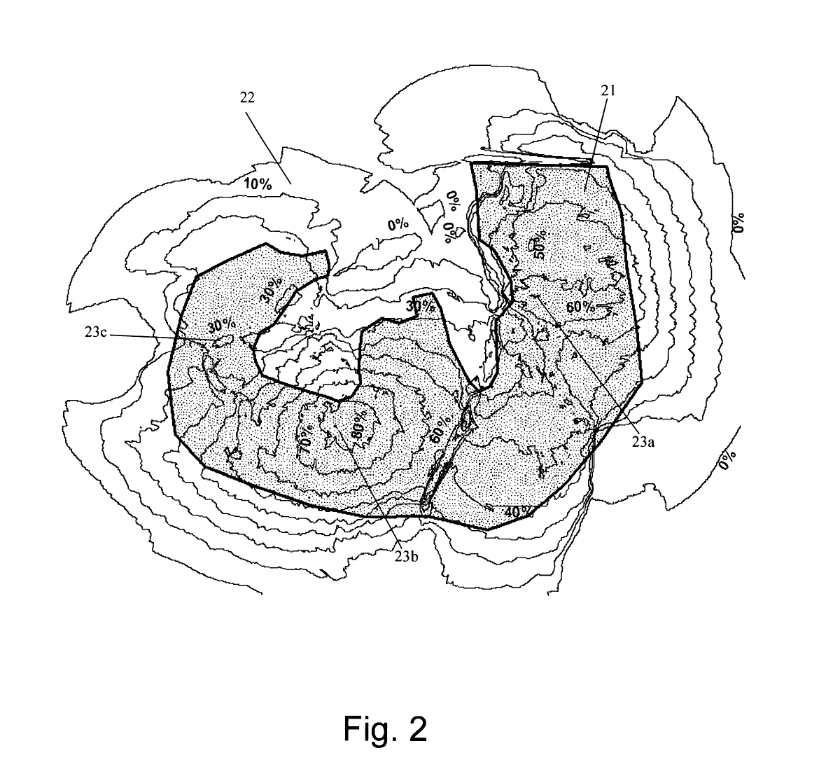

FIG. 2 schematically illustrates a product of a preliminary analysis session of a site. Based on the polygonal specification of the target area for coverage—21, and the attributes of the surveillance sensors available for deployment, the system is able to point on a plurality of locations at which, said surveillance sensors may be deployed, to deliver the best coverage of said specified target area. Such recommended locations for sensors deployment is calculated by sampling of the target area and generating a backward coverage analysis from each of said sampled points of the target area. The coverage analysis is performed from said sampled target area outward—towards the whole region surrounding the target area, up to a range limit imposed by the surveillance sensor. These coverage analyses from all of said sampled points within the target area are aggregated, so locations with the maximum aggregated number of coverages, constitute locations with coverage to the maximum number of sampled points within the target area. Such locations represent the best locations for the deployment of said surveillance sensors that are expected to deliver the best coverage of said target area. Such attribute of the analysis, calculated outward from the sampled target area, turns the analysis product into a continuous surface of rankings—22 for the whole region surrounding the target area. Within such ranking surface, local maxima points such as numerals 23a, 23b, and 23c represent suggested optimized locations for the system's sensors that may be evaluated off-site by the system designer for preliminary bidding. In addition, these optimized locations may be further physically assessed through field surveys during detailed design.

A map produced from this continuous surface of rankings of the entire region, may be utilized by site survey teams, to focus the team's field work, solely on validating the logistic feasibilities of said suggested sensor locations. Such directed and focused field site surveys enable substantial reductions in expenses and duration of detailed system design.

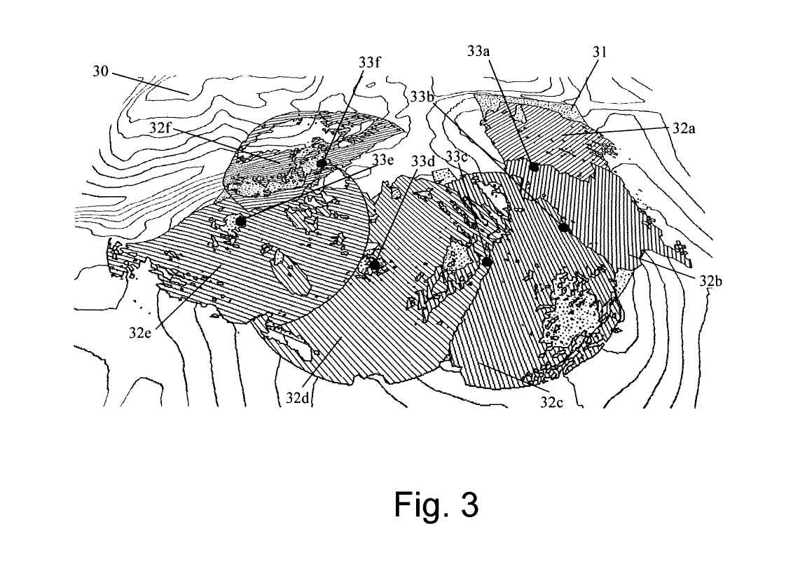

FIG. 3 illustrates a system wide coverage analysis, based on the terrain model—30 and said specification of the target area—31. The system wide coverage is attained by a union of the coverages 32a through 32f produced by sensors deployed at the set of locations 33a through 33f. Such locations may be found from said local maxima points within said location ranking surface—23a, 23b and so on as illustrated in FIG. 2. The system wide coverage analysis demonstrates the expected coverage of each of the separate sensors as well as the overlap between coverages of adjacent sensors, visualizing the overall coverage expected to be delivered by the system.

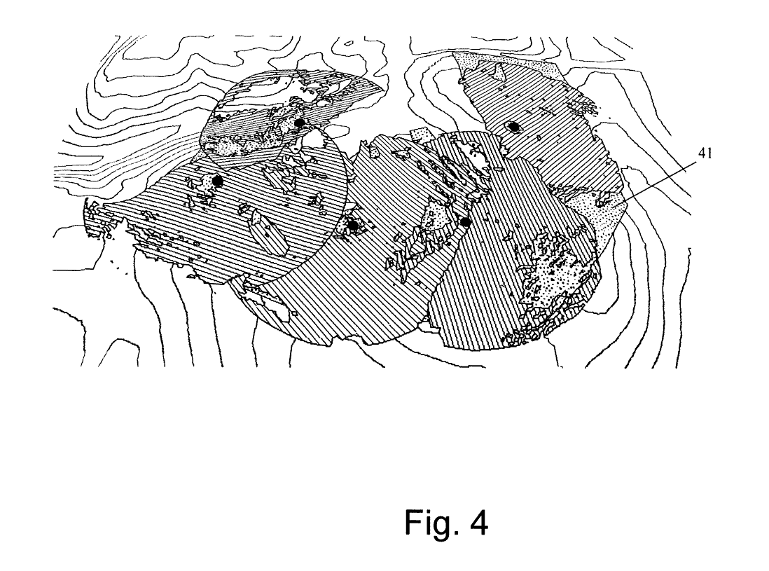

The product of the system-wide coverage analysis is assembled in an open and layered format, facilitating further optimizations and trade-off decision-making through standard viewing tools. Such layered structure of the analysis product, enables the designer to add or omit various suggested or alternative sensor locations within the planned system, demonstrating the added coverage delivered by each and every potential location of the system's sensors. This way, sensor locations that deliver limited added coverage may be replaced by an alternative location, or even omitted completely from the overall system's coverage. Such scenario is exemplified in FIG. 4 by the omission of the coverage delivered by the sensor at location 33b in FIG. 3. The minor gap—41 within the overall system's coverage, caused by such omission, might be assessed and approved by the customer. Such visualization capabilities allow various design considerations to be disclosed and demonstrated to the end-customer, reducing the risk of alterations required upon delivery of the final system.

The deployment of radar based security systems often requires physical surveys and even field tests with actual hardware to validate the detectability of threats within the required area. As active radio based sensors, radars are influenced by radio energy reflected back by the ground, namely ground echoes or clutter. Zones which reflect strong radio energy back to the radar are considered “high level clutter zones”. These zones may saturate the radar's receiver, hindering intruders' detectability by the radar. Major physical factors influencing the radio energy's back reflection or clutter level include the range to the radar sensor, the grazing angle of the transmitted radio ray hitting the ground, the radio wavelength and the physical characteristics of the ground's surface.

The geometry of the radar's location and the field's terrain structure may be utilized to generate an estimation of a radar's clutter level map by calculating the range or the grazing angle within zones with line of sight—observable by the radar. Further, characteristics of the radar's transmission and mapping information of the ground may add physical characteristics, further supporting the clutter level estimations. In addition, such estimation of the radar's clutter level can be calibrated to a specific model of the radar to reflect zones that although are optically observable by the radar, are in fact “hidden” in terms of intruders' detectability. Such estimation of physical attributes, or even some of them, influencing deployed radars, may demonstrate the true operational detection coverage of the radar sensor from its intended location. In the lack of capability to fully calibrate a specific model of a specific radar sensor, such clutter map estimation can be used to pinpoint the weakest zones within the sensor's detection coverage that should be further scrutinized.

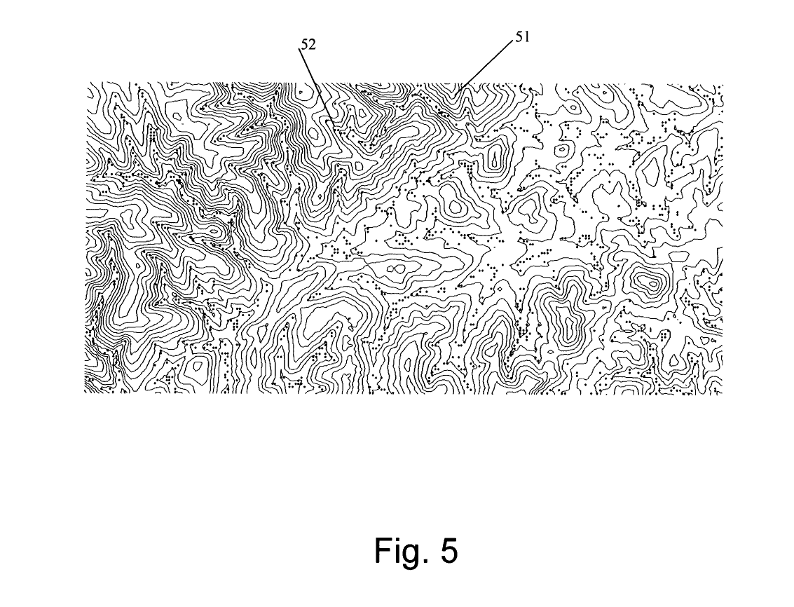

At times, the specified target area for coverage is vastly wide, in a way that regular sampling of said target area would generate a huge amount of sampled points from which a coverage analysis should be calculated per each point. Prior art techniques to reduce said amount of sampled points is through reduction of sampling density. Such techniques are limited in effectiveness, for the fact that excessively sparse sampling may miss some terrain features, distorting the sampled terrain's structure and causing erroneous coverage calculations. As illustrated in FIG. 5, the present invention adapts the sampling scheme to the terrain's shape. The terrain—51, is sampled along its depressions and slits, representing rivers, ravines and valleys within the sampled area—52. These features of the surface, spotted by water flow and drainage basin techniques for terrain analysis, represent spots within the sampled area, which are hidden and therefore more difficult to cover by deployed sensors. Furthermore, locations of sensors that do cover such hidden spots along the bottom of rivers, will usually cover the wider drainage basin area, of that same river, typified by more elevated terrain. Due to the fact that a typical wide and hilly area can be effectively sampled through the sampling of its river lines, can dramatically reduce the number of sampled points, while effectively and densely representing the profile of the area with regard to coverage analysis. Such reduction in sampled points will considerably decrease the complexity of coverage analyses, locating the best covering sites for the area.

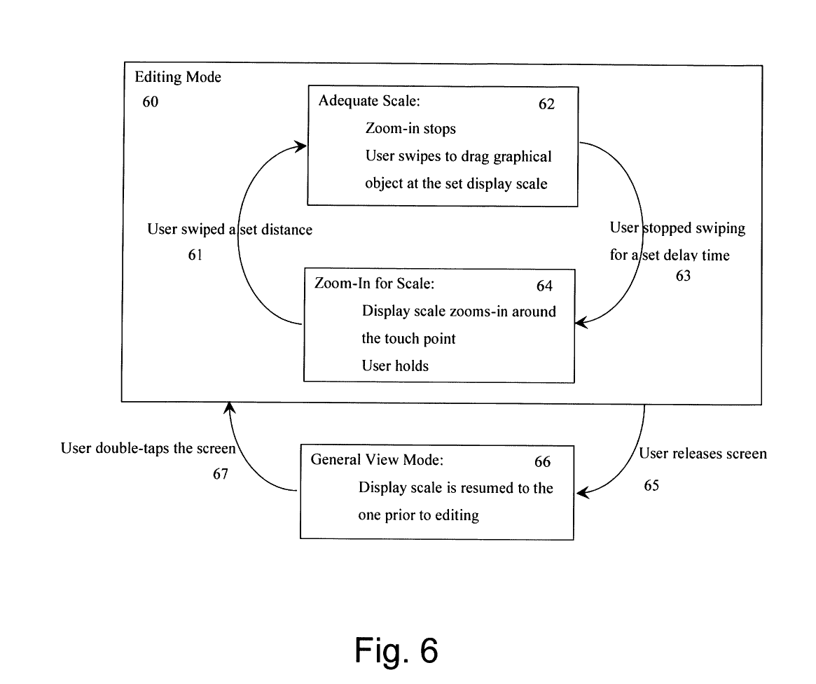

According to another embodiment of the current invention, FIG. 6 illustrates a method for precision editing of graphical objects by simple gestures. This method is applicable for touch screen mobile devices during field surveys, where there is no access to a full featured planning workstation and desktop grade interface means like mouse and keyboard. The method enables combined manipulation of graphical objects, while enabling fine adjustments of the display's scale.

Graphical software vendors of desktop workstations utilize the desktop environment's advanced and flexible user inputs such as keyboard, mouse and other means of user input. Such desktop grade interface means enable the user to conveniently fine edit graphical objects, e.g. by means of mouse-dragging operations while manipulating the scale of the display, e.g. by means of the mouse's scrolling wheel. On the other hand, touch screen gestures, common in mobile platforms, lack these combined and rich combined manipulations, typical of desktop environments. Accordingly, prior art touch based interfaces, may allow the user to perform one operation at a time through distinct gestures, which force the user to switch back and forth between object dragging for editing and display scale setting in an awkward way.

According to the embodiment of the current invention, the touch interface will be applied with the convention, as shown on FIG. 6, to enable said double action. Through this convention, once the display is in edit mode—60, a swiping gesture of the finger or any other pointing device—61, shall indicate an object drag for editing operation, for which the display scale is adequate and no further scale adjustments are required—62. On the other hand, a stable holding gesture of the pointing device—63, shall imply that the current display scale is too coarse and therefore, further zooming-in operation is required—64. Thus, if the display scale is detailed enough for editing, the user may initiate a move gesture, such as swipe the touch screen, to move an object pointed at for editing. If, on the other hand, the editing requires finer display scales, the user may hold the pointing device, in order to further zooming-in around the held point. After reaching the proper display scale, the user may start moving his pointing device, to indicate that, now, he can conveniently drag the object for editing. This will halt the zooming-in operation and preserve the display scale. Completion of the editing will be signaled by the user, releasing his pointing device or finger—64. This will exit the editing mode—60 and get back to the general view mode, while zooming-out operation may be also performed to show an overview of the edited object—66. Getting back to edit mode will be done by a different gesture such as a double tap or any other distinct gesture—67.

According to another embodiment of the current invention, the two actions of zooming-in and object dragging for editing shall be distinguished in order to reduce excessive transitions between these two operations. The transition into zooming-in operation from object dragging for editing operation, as a result of the user stopping his swiping action, shall be delayed by a set amount of time. Similarly, the transition back to object moving operation, as a result of the user regaining his dragging action, shall be gated to a set degree of movement and performed only after the user has moved his pointing device a certain set distance on the screen.

According to another embodiment of the current invention, those set delay and gated movement may be tuned according to the smoothness of the individual user's typical movements and gestures. Also, the speed of zooming-in and zooming-out operations may also be fine-tuned and fitted to the individual user's gestures and preference settings.

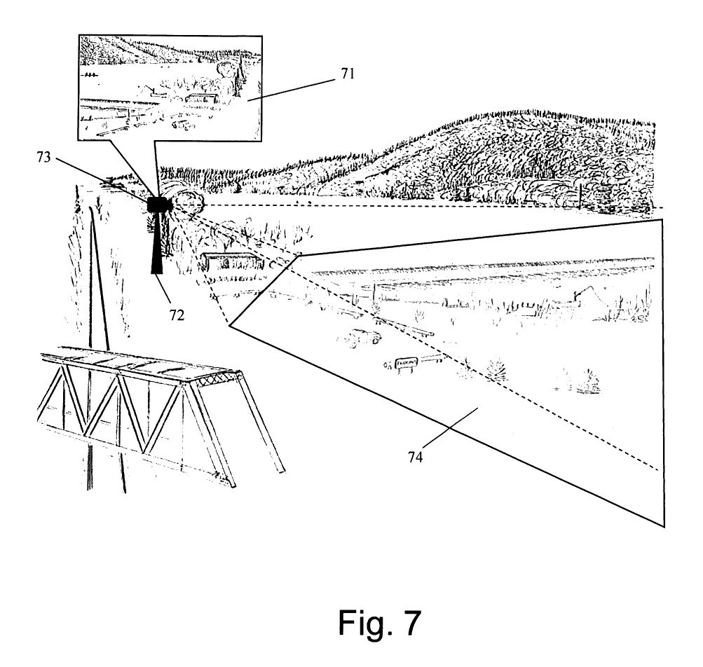

FIG. 7 illustrates geo-referencing of updated and detailed images, taken in the field, either by one of the system's deployed cameras, or prior to deployment, by a mobile device's camera, during field site surveys. Surveillance workstations utilize imagery data of the site and its surroundings as the background to its geographical display. Such imagery background greatly supports the operator's orientation while assessing the exact locations of events within the monitored site. Imagery data that covers the entire monitored area, is usually acquired from satellite or aerial imagery services. Such acquired imagery data is often outdated or limited in resolution and detail, failing to properly represent the actual status of the monitored area as the operator should be presented with. The current invention; allows to augment the original acquired imagery data with complementary imagery data, captured during site surveys or during the life cycle of the system. Such capability of updating and adding details to the system's geographical display, allows decreasing the dependency in external sources of imagery data and enables maintaining the system's dependability, even in highly changing environments. The geo-referencing of images captured in the field—71 in FIG. 7, is based on the availability of location and orientation information of the camera, capturing said imagery data in the field. Location information, will include the exact positioning coordinates—72 and height above ground—73 of the camera's lens. Orientation information shall include the azimuth angle as well as the elevation angle above or below the horizon towards which the camera is oriented. Such data shall allow the calculation of the spatial coverage of the field of view captured by the camera—74. In case the imagery data is captured by a mobile device during a site survey, the internal GPS and orientation sensors may be utilized to measure and register such information regarding the exact location and orientation of the camera while the imagery data is captured. For imagery data, captured by the system's deployed cameras, such location and orientation information are usually measured and available constantly from deployment, through the surveillance system's command and control software.

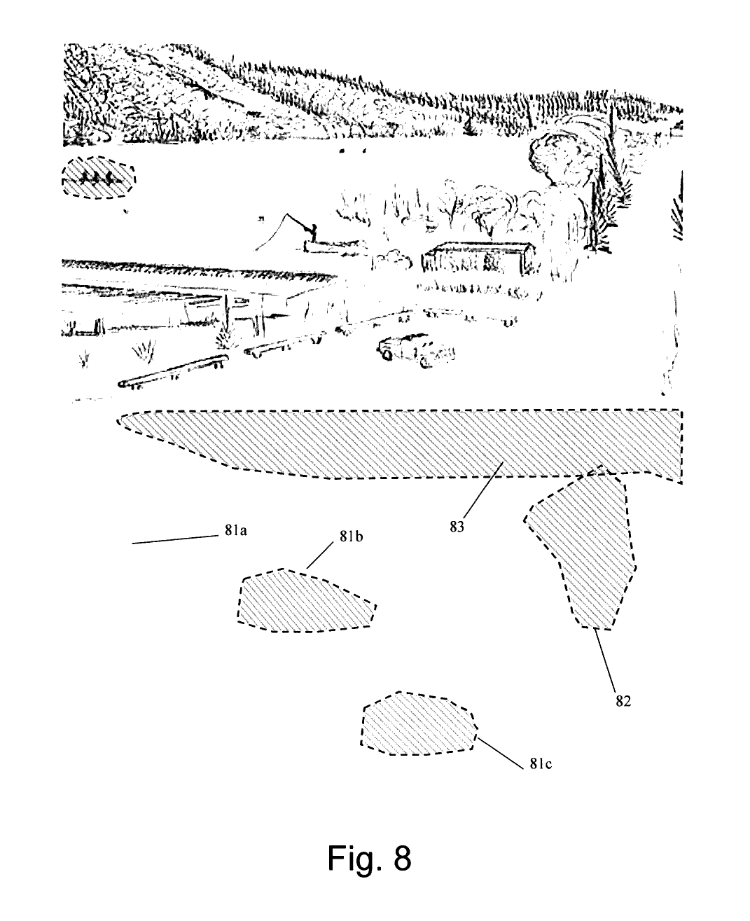

As opposed to satellite or aerial imagery, imagery data taken from ground level includes sizeable objects, which block a considerable portion of the area behind them. Such sizeable objects may erroneously be geo-referenced into the geographical imagery representation of the area. In addition, there might be other temporary objects, which are not representative of the monitored area. In order to prevent these objects from cluttering the captured image, the current invention includes a blanking mechanism, as illustrated by FIG. 8, which allows the user, while capturing the image, to set temporary objects as exemplified by numerals 81a, 81b and 81c, or blocking objects—82, as transparent zones within the captured image. This way, the blocking object, blanked from the captured imagery data, will not clutter the geographical display, allowing the blanked area to be represented by the originally acquired satellite or aerial imagery data of the site.

Another characteristic of ground captured imagery data, is a non-homogenous resolution of the geo-referenced images. Areas close-by to the capturing camera benefit from great detail and resolution, while distant areas are typified by lower spatial resolution. In order to maintain a consistent quality of the geo-referenced imagery data, the user will be prompted to select a preference of “Detail” vs. “Update”. In “Detail” mode, the geo-referenced imagery data will be used only in areas with spatial resolutions, which is higher compared to a resolution set by the user that may already be available through acquired imagery data, while other areas with lower resolution will be blanked as exemplified by numeral 83. In case “Update” mode is selected, the whole geo-referenced captured imagery data will be used with no regard to its spatial resolution.

This way, by capturing multiple geo-referenced images, from various locations within the field, a highly detailed and updated representation of the monitored area can be attained.

Actual sensor deployment planning is an incremental process, conducted in the field on a location by location basis. Site survey teams have to consider a variety of aspects in order to devise the right locations for the system's sensors that will deliver adequate coverage of the specified target area. In addition to coverage, such locations must be logistically feasible for raising sensor posts as well as for maintaining these posts during the whole life cycle of the system. Therefore, the final decision, ratifying a location for a sensor can be taken only in the field. Prior art computational optimization and validation tools perform the calculation of optimal locations through a single session, producing a whole layout for all the sensors at once.

Requirements related to overlapping coverages of adjacent sensors, often impose tight dependencies between various sensor locations, constituting the whole plan. Therefore, in an occasion of a planned location, being disqualified during a field survey, the whole plan may collapse, even if some of the other locations may have been already ratified. This forces the computational process to be restated to produce a whole different set of locations for all the sensors. The current invention modifies the sensor emplacement computation scheme to be conducted incrementally, so system design workflows are adequately aided by coverage optimization and validation tools.

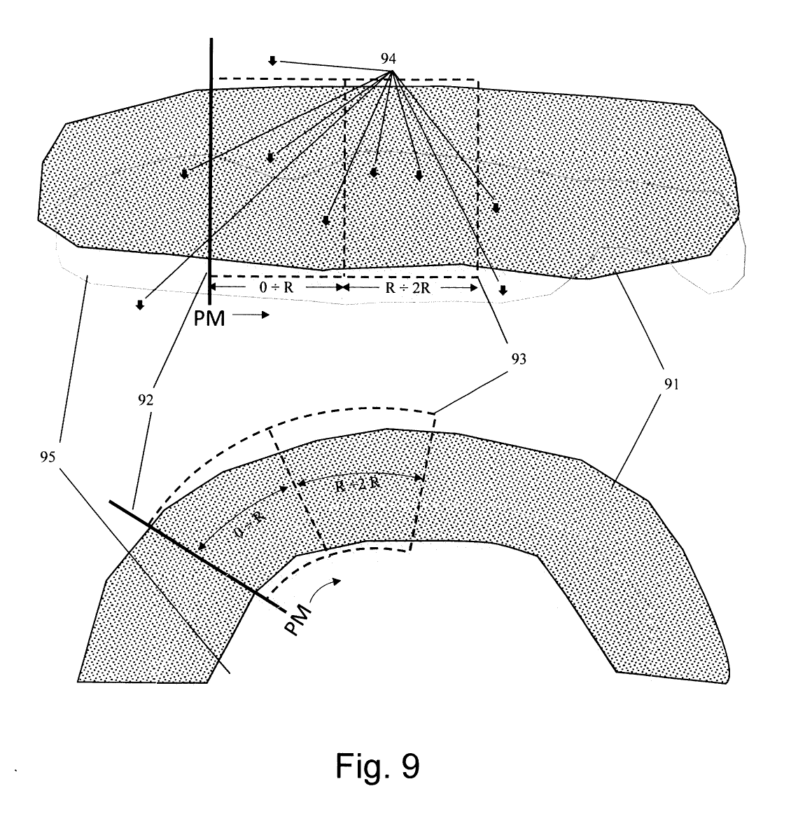

FIG. 9 schematically illustrates the basic principal of the current invention through an example of a specified target area, reflecting a specified perimeter. The target area can be defined as either straight or circular—91, or any other shape of target area, or shape of uncovered gap within a target area. In perimeter based applications, the selection and deployment of sensors is done in a way that covers the perimeter by a chain of adjacent sensors, deployed along the perimeter's longitudinal or circular axis, where a single sensor can sufficiently cover considerable portion of the width of the specified target area.

According to such deployment paradigm, a longitudinal or a circular Perimeter-Marker (PM)—92, is defined, which will be incrementally advanced through the planning session, from a certain edge of the specified target area towards its opposite edge. Attached to the PM, and further along the longitudinal or circular axis, a rectangular or sectorial frame is defined—93. This frame is in average, twice as long as the range of the intended sensor (marked R in FIG. 9) and wide enough to cover the whole width of the target area. The frame is further divided into two halves, each with an average length as the range of the intended sensor. A portion of the target area—91, defined as the intersection of the specified target area with said frame—93, is analyzed as a local segment of the target area, used for a local best-sites analysis, similarly to the one illustrated in FIG. 2, to produce a location ranking surface for the region surrounding said analyzed segment of the target area. The resultant ranking surface is typified by local maxima points, exemplified by numerals 94 (only in the straight area's upper illustration), reflecting suggested a-priori locations for deployment of a sensor that will best cover said segment of target area. Further, the area applicable for sensor deployment is also flexibly defined by a polygon—95, to limit the deployment by rejecting regions, unfeasible or unacceptable for sensor deployment.

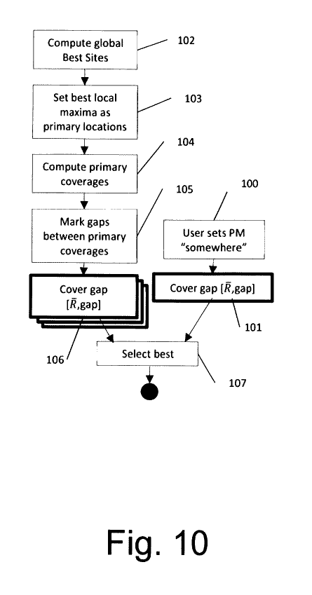

The incremental method of sensor emplacement is a layered process, illustrated in FIG. 10 through FIG. 13. First, the PM has to be reset to a certain edge of the specified target area. In a long, or circular target area, the first position of the PM has to be decided either by the user in step 100 forward to the gap coverage procedure—101, or by a preliminary global analysis—102, of the whole target area, similarly to the way outlined by FIG. 2. The resultant global best-sites-surface is searched for local maxima points in step 103, which will point on a list of the global primary best sites for sensor deployment. The coverages computed from such primary locations in step 104, will effectively subdivide the whole specified target area into a set of more localized gaps—105. Consequently, each of these local gaps will be further analyzed for coverage—106. The final selection between various user settings of the starting point of the PM and the computing of the global primary locations can be determined through assessment of the results by a collection of budgetary or other criteria—107.

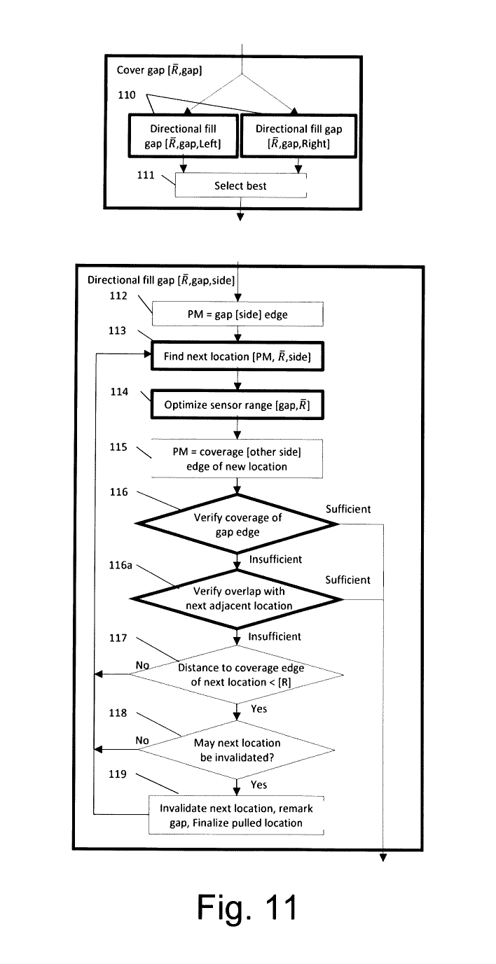

FIG. 11 illustrates the next layer of the process, through which, both sides of the required gap and their corresponding opposite directions of gap filling are assessed in step 110. The direction which produces a sufficient coverage of the required gap, with less sensors or expected expenses will be selected in step 111. In cases of limited computation resources, such double hypothesis stage can be omitted, preselecting the edge of the gap to start from and the corresponding direction of gap filling.

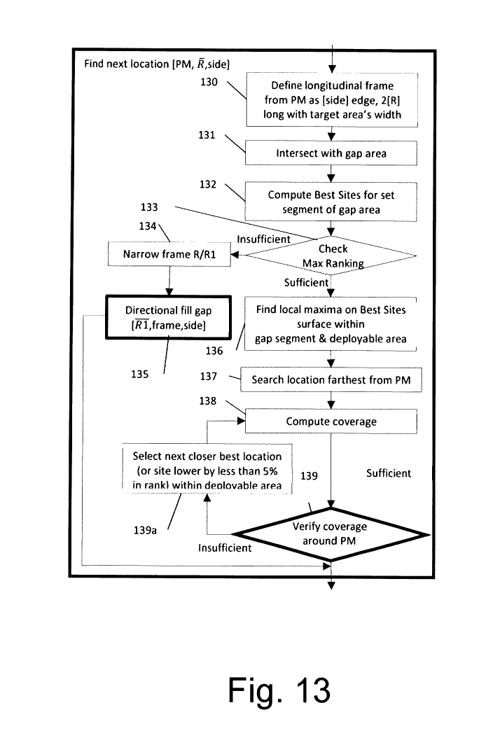

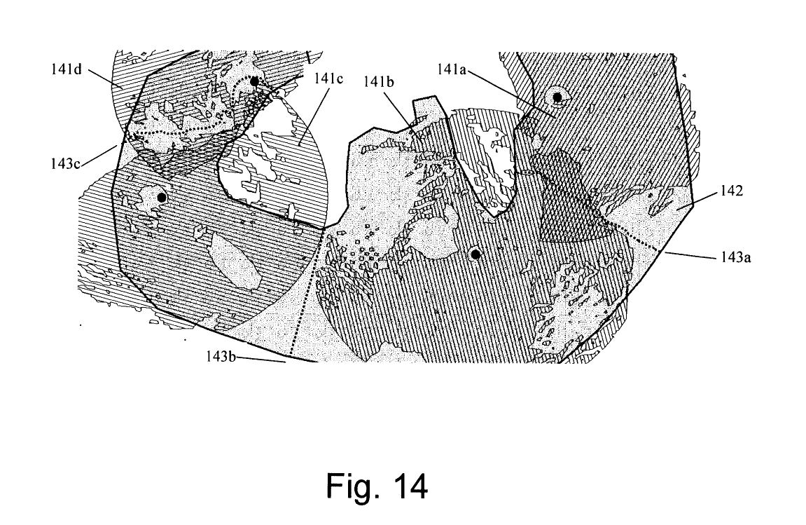

A directional gap filling procedure is engaged according to the set gap, the side from which the starting point is set for filling and the collection of sensor ranges—available for deployment (marked R̅ in the figures). Through this procedure, the Perimeter Marker—PM is set to the set left or right edge of the gap in step 112 and accordingly, the next location for deployment is computed in step 113 as will be further explained below in FIG. 13. The resultant coverage of this next location is further optimized in terms of the sensor range in step 114 as will be outlined below in FIG. 14, and the PM is advanced in step 115, along the longitudinal or circular axis of the specified target area, to the farthest position near the far edge of the coverage, calculated from the newly added location.

The newly added location is tested for coverage of the opposite edge of the required gap in step 116, so if this edge is sufficiently covered, the coverage of the gap is assumed to have completed. In case the edge is not sufficiently covered, there is a need for further more sensors to properly cover the gap and the process continues. In cases the far edge of the required gap is a result of a coverage edge of another sensor already defined beyond the gap's edge, the terminating condition is implemented in step 116a through a test of sufficient overlap between the coverages of the newly added sensor and of the already defined next adjacent sensor. This way, through the filling of the gap, sensors with overlapping coverages are incrementally added to properly cover the defined gap. As the process approaches the gap's edge, and in case the remaining uncovered gap is small, compared to the range of the sensor as tested in step 117, and only in case the location of the next sensor is not yet ratified or finalized by the survey team or by the user as tested in step 118, an attempt is made to “pull” the location of this already defined next sensor to have the remaining gap closed without adding an additional sensor. This is done by invalidating the location of the next sensor in step 119, and moving the edge of the defined gap to the coverage edge of its next adjacent location. Such invalidation forces the mechanism to find a new location for the invalidated location that will deliver an adequate coverage overlap with the last computed location. Said invalidation of locations is repeated until the gap is properly covered or until an already finalized sensor location is reached, forcing the addition of another sensor to cover the remaining gap. In order to prevent a perpetual circulation of such “pulling” of locations in a circularly specified target area, a “pulled” location will be also marked as finalized.

This emplacement mechanism may be elaborated to count for various types of sensors, with differing ranges. Such availability of multiple sensor types with different ranges is utilized through the default deployment of the longer range sensors as the major sensors, while the remaining coverage gaps are covered through the usage of shorter range sensors, acting as cost effective gap fillers.

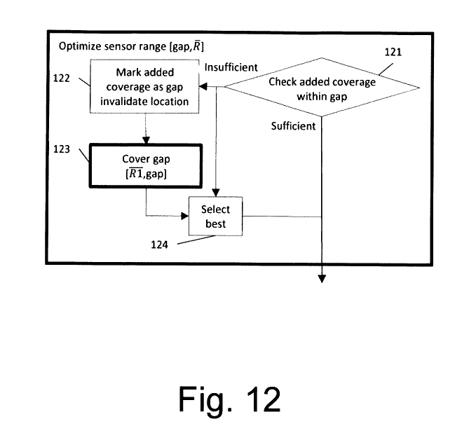

FIG. 12 elaborates step 114, from FIG. 11, outlining the way each coverage, produced by a newly computed location is checked for its added contribution to the overall coverage of the gap. In case the added non-overlapping coverage, produced exclusively by the new location, is found in step 121 to be marginal, an attempt is made to cover this region by a sensor, shorter in range and cheaper in price. This is done by defining said added coverage, in step 122, as a gap and covering it in step 123 by the collection of the other, shorter in range sensors, available for deployment and marked R̅1̅ in FIG. 12. The resultant coverage, attained through the utilization of the shorter range sensors is compared with the original coverage, produced by the longer range sensor, and the better alternative in terms of budget or any other set of criteria is selected in step 124.

FIG. 13 illustrates the core procedure (from step 113 in FIG. 11) of computing the location of the next sensor in each and every step through the incremental process of filling a defined gap. The procedure is engaged with a list of parameters set according to the longitudinal or circular position set for the PM, the collection of sensor ranges available for deployment and the set direction of gap filling.

As schematically outlined above in FIG. 9, localizing longitudinal or circular frame is set in step 130, based on the position of the PM, further along the target area's longitudinal or circular axis, up to a coordinate of PM+2R, where R is the longest within the collection of ranges of sensors available for deployment. This frame is intersected with the required gap area in step 131 to limit the analysis to the required gap area within the localizing frame. A best-site analysis is performed in step 132 as outlined in FIG. 2, to produce a ranking surface for the coverage of said localized portion of the required gap area.

Said ranking surface is assessed for its maximum ranking values in step 133. Excessively low rankings indicate small percentage of coverage attainable by the best locations for the sensor used for the analysis. This suggests that said sensor range does not fit to the characteristics of the analyzed segment of the gap area, and that a sensor with shorter range may be preferred. In this case, the target area definition is adjusted in step 134 to the range of the next shorter range sensor available for deployment, by narrowing the width of the localizing longitudinal or circular frame and the process is recursively launched, in step 135, with the parameters including the updated collection of sensor ranges (marked—R̅1̅), which omits the range of the largest sensor range, the narrowed localizing frame—representing the required gap for coverage by the shorter range sensors, and with the same direction of gap-filling as defined earlier. Such recursive procedure will ultimately compute the locations of the longest range sensors that will adequately cover the said frame segment of the defined gap.

In case said ranking surface indicate sufficient rankings in step 133, the longer range sensor will be assumed to fit with the characteristics of the localized segment of the required gap and therefore the process goes on by searching for a set of local maxima points, reflecting the suggested locations for sensor deployment that will best cover this segment of the required gap. Out of the suggested locations, those that are within a polygon representing the defined applicable area for deployment, are selected in step 136 and sorted by their longitudinal distance to the PM, from the farthest to the closest. In step 137, the farthest site from the PM is selected out of said sorted list and calculated for coverage in step 138 through the utilization of the coverage model, appropriate for that specific type of sensor. The resultant coverage is tested in step 139 for adequate coverage around the PM, to verify the coverage at the starting point near the gap's edge, or to verify the overlap of the coverage attained by this location with the coverage edge of the formerly computed adjacent location. In case the coverage is insufficient, the next suggested site, closer to the PM, shall be selected in step 139a from said sorted list produced by step 136. There might be cases where the ranking surface around the suggested location is flat in a way that allows “moving” the suggested location away from its computed local maximum, without considerably decreasing the resultant coverage of the sensor. In such cases, where the ranking is decreased by no more than 5%, or any other set margin, compared to the ranking at the local maxima point, the suggested location may be “pulled back” towards the PM, to close the gap found in step 139.

This process, of searching for a location closer to the PM, is repeated until a sufficient overlap is attained with the coverage produced by the formerly adjacent computed location or to the edge of the required gap. The suggested location, fulfilling the condition in step 139 is set as the suggested location for this next sensor.

FIG. 14 schematically illustrates an overlap verification in 3 cases. Such verification may be conducted by first unifying the two adjacent coverages tested for overlap—141a with 141b, 141b with 141c and 141c with 141d. The resultant unified coverage may be used as the spatial weighting function for a standard route calculation procedure. Such procedure shall search the route, between two points residing in the two opposite sides of the defined target area—142, which accumulates the minimum number of steps through zones that are covered by said unified coverage—143. In case the accumulated weighting value, of such calculated route, exceeds a given threshold, the path shall be regarded as “covered” by the unified coverage.

The suggested locations found for the system's sensors are validated through field site surveys. A location, validated and ratified by the survey team, is registered as a finalized location. On the other hand, some of the suggested locations may be disqualified by the site survey team. The incremental characteristics of the above sensor emplacement method allows it to locally adapt the sensor placements, recalculating the disqualified location and maybe some of its close-by locations, while maintaining the rest of the sensor locations intact.

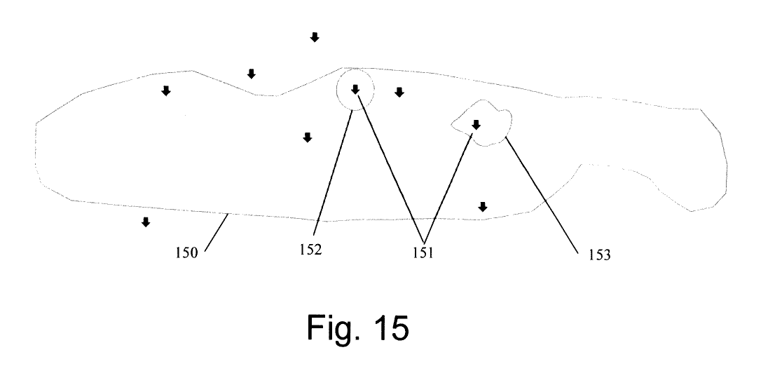

FIG. 15 schematically illustrates the spatial view of disqualifying a suggested location. The area applicable for sensor deployment is initially outlined by a user defined polygon—150. In case the user disqualifies a location—151, a circular region around set disqualified location is extracted—152 from the polygon of applicable area for deployment. The user is prompted to further elaborate and finely outline the disqualified zone—153.

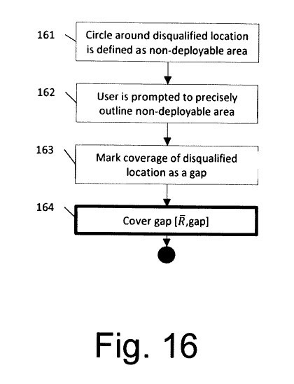

FIG. 16 illustrates the process initiated when a suggested location is disqualified. A circle representing the close proximity around the disqualified location is first defined as a non-deployable area in step 161, and the user is prompted in step 162, to more precisely set the radius and the exact shape of said non-deployable area around the disqualified location. This shape of disqualified region is extracted from the defined applicable area for deployment, and the coverage of the disqualified site is marked, in step 163, as a required gap for coverage to be recalculated. Such disqualification of a sensor location, launches the gap coverage procedure (defined in FIG. 11) again in step 164.

While some embodiments of the invention have been described by way of illustration, it will be apparent that the invention can be carried out with many modifications, variations and adaptations, and with the use of numerous equivalents or alternative solutions that are within the scope of persons skilled in the art, without exceeding the scope of the claims.

1. A method for planning the deployment of a sensor based surveillance system to cover a required target area, employing a-priori model of the area, calculating a continuous ranking surface for the whole area as to the percentage of coverage of said specified target area attained by deploying defined sensors.

2. The method according to claim 1, wherein the continuous ranking surface for the whole area is used for calculating optimal locations for a plurality of sensors to cover said specified target area.

3. The method according to claim 1, employing a-priori model of the area, layering the calculations of expected coverages attained by the deployment of set sensors at set locations according to the attributes of said sensors.

4. The method according to claim 3, wherein the layered coverages are formatted in an open format for review by standard tools.

5. A method of modeling a ground radar sensor by estimating its clutter map from set location of deployment.

6. The method according to claim 5, wherein the estimated clutter map is calibrated to reflect operational detection coverage estimate.

7. A method for efficiently and effectively representing the terrain of a wide area for coverage analysis by sampling it along its depressions and slits.

8. A method for precisely outlining of graphical objects within a graphical display by using a hand gesture operation.

9. A method for overlaying field captured imagery data over acquired imagery data used as the background of the geographical display of a surveillance system.

10. The method according to claim 9, wherein temporary objects or objects blocking the field within the image are blanked out from the overlaid image.

11. The method according to claim 9, wherein zones within the image with low spatial resolution are blanked out from the overlaid image.

12. The method according to claim 2, wherein calculation of the optimal locations for sensor deployment is limited to an area applicable for deployment of sensors as outlined by the user.

13. The method according to claim 2, wherein calculation of the optimal locations for sensor deployment is performed incrementally on a site by site basis.

14. The method according to claim 13, wherein calculation of the optimal locations is aimed to assure the coverage of a defined target area by a plurality of sensors with overlapping coverages.

15. The method according to claim 14, wherein disqualifying a sensor location initiates a calculation of alternative locations for sensors that will cover the resultant gap.

16. The method according to claim 14, wherein the calculated coverage is optimized for the range of the sensor used.

17. A method for verifying the coverage overlap of adjacent sensors by employing optimal route calculation mechanism.

18. A system for planning the deployment of a sensor based surveillance system to cover a required target area, employing a mobile terminal device held or carried by a field site survey team wherein said terminal calculates and displays a map of best sites for deploying sensors to cover a specified target area, calculates and displays layers of coverages of the various sensors from said best sites.

19. A system according to claim 18, further comprising an incremental planning module that allows a survey team to ratify or disqualify suggested sensor locations while adapting the overall plan to said ratifications and disqualifications.

20. A system according to claim 18, employing a mobile terminal device held or carried by a field site survey team wherein said terminal allows the user to precisely outline graphical objects in the field.
